(19) United States
(12) Patent Application Publication
(10) Pub. No.: US 2009/0223898 A1
(43) Pub. Date: Sep. 10, 2009

(54) Industrial Silicon Carbide Filtration Method

(76) Inventor: Yousef Haj-Ahmad, St. Catherines (CA)

Correspondence Address: MYERS BIGEL SIBLEY & SAJOVEC, PO BOX 37428, RALEIGH, NC, 27627, US

(21) Appl. No.: 12/065,147

(22) PCT Filed: Aug. 29, 2006
(86) PCT No.: PCT/CA06/01412

§ 371 Date: Aug. 11, 2008

(30) Foreign Application Priority Data
Aug. 31, 2005 (CA) 2,517,770

(51) Int. Cl. B01D 37/00; B01D 24/46; B01D 37/02; B01D 39/06

(52) U.S. Cl. 210/639; 210/807; 210/792; 210/777; 210/672

(57) ABSTRACT

A method for use in industrial processes is disclosed for removing substances from a liquid, comprising passing said liquid through a filter bed comprised of silicon carbide particles of either a uniform particle size or decreasing particle sizes. The filter bed can be washed and regenerated by directing a regenerate liquid or liquids through the filter bed. Furthermore, a method for the removal and recovery of products and by-products from a liquid is disclosed, comprising passing said liquid through a filter bed comprised of silicon carbide particles of either a uniform particle size or decreasing particles sizes. A regenerate liquid or liquids can be passed through the filter bed for the purpose of removing and recovering the products or by-products, and simultaneously regenerating the filter bed.

### FIELD OF THE INVENTION

The invention relates generally to the field of filtration in industrial processes. More particularly, the invention relates to methods of filtration in industrial processes for removing substances from a liquid using cake filters, pressure filters, vacuum filters, deep bed filters or surface filters comprised of an inexpensive, environmentally-friendly filter media that can easily be regenerated and re-used or using that material as a filter aid, in combination with other membrane or surface filters.

### BACKGROUND OF THE INVENTION

Filtration, the removal of suspended particles from a liquid, has a wide-spread industrial application. In the pharmaceutical and biotechnology industries, filtration can be applied to the separation of cells or cell fragments from fermentation media, particle filtration of vaccines, particle filtration of blood plasma, purification of reagents, filtration of cosmetic oils, filtration of herbal extracts, and the separation of activated carbon, along with many more applications. For the food and beverage industry, the many applications of filtration include clarification to sterilization of beer, wine, juice and juice concentrate, vinegar, sugar syrup and olive oil. Filtration is also used for various chemical applications including the purification of solvents, catalyst recovery, petrochemical products, and ink filtration among others. Thus filtration plays a very important role in various stages of many industrial processes.

The process of filtration refers to forcing a particle-laden liquid or feed stream through a filter fabric or media of predetermined pore size. The driving force can be gravity, pressure or vacuum. Suspended particles in the feed stream are trapped on the surface of the filter media while the clarified liquid passes through the filter. The filtration processes are aimed at 1 of 2 results, either to collect the liquid or to collect the retained particles or sludge.

To function as a filter, media must allow the fluid, commonly water, through while holding back the particulate contaminant. This holding back of the contaminant is accomplished by one or both of two distinctly different filtration mechanisms, namely (1) mechanical straining, and (2) adsorption. The most simplistic type of filtration is referred to as surface filtration, and this involves passing the liquid through a fabric or cloth.

One of the main drawbacks of surface filtration is that the filter media can become obstructed or blinded within a short period of time. As filtration proceeds, unwanted solids collect on the filter or filter medium. These solids lack sufficient permeability, and thus filtration proceeds very slowly or terminates due to pressure increases. One way to circumvent this problem is by coating the selected filter medium with a thin layer of filter aid or precoat. The precoat layer retains the solid to to be filtered out without simultaneously obstructing the flow of the filtrate through the filter media. In this manner, the precoat layer protects the filter media against premature blocking and extends the filter operating cycle. Precoat also facilitates the subsequent cleaning of the used filter cake, by helping to loosen the tight cake that would otherwise be formed. The filter aid also serves to improve the performance of the filter fabric because the large internal surface area of the precoat increases the available area for particle removal.

The first type of filter aids used were inorganic mineral powders including diatomaceous earth (diatomite) and aluminum silicate (perlite). The use of filter aids and precoat filtration is common in a wide number of industries, including chemicals, food processing, pharmaceuticals, mining, municipal water treatment and waste treatment.

Closely related to filter aids is the use of depth filters. Depth filters have a thicker, three-dimensional media that creates a longer, tortuous path for the particles to pass through. To be a true depth filter, the filter must be able to retain contaminants throughout the entire cross-section of the filter. To accomplish this, the density must increase progressively from the exterior surface to the interior. Typical applications of depth filtration are in pharmaceuticals and biotechnology, beverage and food industries, and chemical applications.

Although filter aids have been used successfully to enhance both surface and depth filtration, there are a number of problems associated with them. For traditional filter aids (diatomite, perlite), there are concerns about health and safety issues, including the long term effects of inhaling the substances. Specific types of diatomite have been known to cause lung problems. Furthermore, because they cannot be regenerated, the costs associated with land fill disposal of the spent filter aids are very high. Further, if contaminated filter cakes from chemical applications are fed to thermal utilization, the high ash content and low intrinsic fuel values of mineral filter aids pose a problem.

As a result of these problems, organic filter aids are steadily replacing these traditional products. Organic filter aids are derived from natural, renewable materials such as wood, cellulose and maize fibers. Consumption of organic filter aids can be up to 70% lower compared to mineral powder, due to low wet cake densities. The fibrous structure, fissured surface and high porosity often result in a higher flow rate and longer filter life. Organic filter aids present neither a health risk nor harmful effects for the environment and nature. They are non-abrasive to pumps and other hardware associated with the filter machines. The disposal of filter residue is easier due to low ash content of organic filter aids. Also, non-contaminated filter aids can be used in land fills, animal feed and composting.

However, a major problem associated with both inorganic and organic filter aids is that once the filter aid has become exhausted, they are useless and must be thrown away or sanitized as waste. This is both an economic burden, as well as an environmental concern. Some advancements have been made towards regenerating and reusing filter aids. In U.S. Pat. No. 5,300,234, a method of filtering beverages and other liquids is disclosed, in which a filter aid composed of a mixture of filter aids of varying morphological and physical components is used. This filter aid forms a cake, and the solid particles retained in the filter cake are rinsed out and the filter aid is regenerated for reuse. In U.S. Pat. No. 5,801,051 a method for removing organic contaminants including yeast cells from a particulate filter is disclosed, such that it can be re-used. Attempts to chemically regenerate filter aids have been mostly unsuccessful, due to the filtration characteristics being negatively influenced and the permeability and filtration intensity of the filter aids being changed.

It is estimated that the total worldwide demand for filter aid is 1 million tons per year, and inorganics are by far the largest share of this amount. Even with their distinct advantages, the amount of filter aids used based on organic materials is only 60,000 tons per year. One main reason is that organic filter aids are many times more expensive, often exhibit filtration properties that do not match those of inorganics, and cannot be regenerated.

Therefore there is a need for method for use in industrial processes for the removal of substances from a liquid using an inexpensive, environmentally-friendly filter media that can easily be regenerated and re-used.

### SUMMARY OF THE INVENTION

Accordingly, the invention provides a method for use in industrial processes for removing substances from a liquid by passing said liquid through a filter bed comprised of silicon carbide particles, which is an inexpensive, environmentally-friendly filter media that can easily be regenerated and re-used. The filter bed can either be comprised of silicon carbide particles of a uniform particle size, or silicon carbide particles of a decreasing particle size, such that in the latter case the filter bed would operate as a true depth filter. The method may include a step of directing a regenerating liquid or liquids through the filter bed in order to regenerate the filter. The filter bed can be incorporated into numerous types of filters, including cake filters, pressure filters, vacuum filters, deep bed filters or surface filters. Furthermore, the silicon carbide bed can be used as a filter aid, in combination with other membrane or surface filters.

The invention also provides a method for use in industrial processes for removing substances from a liquid by passing said liquid through a filter bed comprised of silicon carbide particles wherein the liquid that passes through the column is collected and used in other applications. The filter bed can either be comprised of silicon carbide particles of a uniform particle size, or silicon carbide particles of a decreasing particle size, such that in the latter case the filter bed would operate as a true depth filter. The method may include a step of directing a regenerating liquid or liquids through the filter bed in order to regenerate the filter. The filter bed can be incorporated into numerous types of filters, including cake filters, pressure filters, vacuum filters, deep bed filters or surface filters. Furthermore, the silicon carbide bed can be used as a filter aid, in combination with other membrane or surface filters.

The invention further provides a method for use in industrial processes for removing and subsequently recovering products or by-products present in a solution by passing said solution through a filter bed comprised of silicon carbide particles. The silicon carbide particles can be of either a uniform particle size or decreasing particle size, such that in the latter case the filter bed would operate as a true depth filter. This method may include a step of directing a regenerating liquid or liquids through the filter bed with the purpose of removing and recovering the products or by-products and simultaneously regenerating the filter bed. The recovered products or by-products could be of value, and may include but are not limited to, nucleic acids, proteins, chemicals, viruses, and bacteria. The filter bed can be incorporated into numerous types of filters, including cake filters, pressure filters, vacuum filters, deep bed filters or surface filters. Furthermore, the silicon carbide bed can be used as a filter aid, in combination with other membrane or surface filters.

### BRIEF DESCRIPTION OF THE DRAWINGS

In drawings which illustrate by way of example only a preferred embodiment of the invention,

FIG. 1 shows filtration curves for the filtration of a citric acid fermentation broth through silicon carbide particles.

FIG. 2 is an SDS-PAGE gel of citric acid fermentation broth filtration compared to another method of filtration.

FIG. 3 shows filtration curves for the filtration of a citric acid fermentation broth through a filter bed of silicon carbide particles, indicating the cut-off point of filtration.

FIG. 4 is a flow rate profile for the filtration of a citric acid fermentation broth through a filter bed of silicon carbide particles.

FIG. 5 is an SDS-PAGE gel of proteins that were recovered from a silicon carbide filter bed after filtration of a citric acid fermentation broth.

### DETAILED DESCRIPTION OF THE INVENTION

The present invention provides an economical, environmentally friendly method of filtering liquids based on the use of silicon carbide, preferably commercially available industrial quality silicon carbide. Silicon carbide is a dark grey, crystalline substance which is insoluble in water, acids and alkalines. Commercial preparations of silicon carbide can be obtained, wherein they are typically composed of greater than 98% SiC with smaller amounts of carbon (C), silicon (Si), silicon dioxide (SiO₂), and iron (Fe) also present. Silicon carbide is also available in a variety of grit sizes or grades and each grade has a different average particle size. Any grade of SiC can be used in the method according to the present invention.

Silicon carbide offers a number of key benefits when used as a filtration media. First of all, silicon carbide is chemically inert, and thus will be non-reactive with any substances that may be present in the fluid being filtered. Furthermore, because it is non-biodegradable, there will be no leaching of the silicon carbide into the filtrate or retentate. Silicon carbide has also been found to be extremely stable in both acid and base treatments, as well as heat. Silicon carbide is also incompressible, thus pressure across the filter will not build up because of compression as filtration progresses. The greatest benefit that silicon carbide offers for the present invention is that it can be cleaned and re-used, thus making it an environmentally friendly alternative to current filtration aids and media. In order to clean and regenerate the resin, a combination of washing and elution steps may be performed. Backwashing may be employed to loosen and remove any mechanically retained substances, while washing and elution will be used to remove any substances which have become absorbed to the silicon carbide. Lastly, the substances removed from the silicon carbide upon regeneration may be useful substances, including nucleic acids, proteins, chemicals, viruses, or bacteria.

In an embodiment of the invention there is provided a method for the removal of substances from a liquid to be used either as a product or in other processes. The primary objective of the exemplary methods carried out was the removal of substances from a liquid by passing said liquid through a filter bed of silicon carbide particles. The filter bed was then regenerated by directing regenerate liquids through the bed. A secondary objective of the exemplary methods was the removal and subsequent recovery of products or by-products from a liquid, by passing said liquid through a filter bed of silicon carbide particles. The products or by-products were then recovered from the filter bed by directing regenerate liquids through the bed, and the bed was simultaneously regenerated in the same way.

In one embodiment of the invention the first step is the generation of the filter bed containing SiC. This bed can be packed with a single grade, or grit size, of silicon carbide. Alternatively, it can be packed with decreasing grit sizes, such that the bed acts as a true depth filter and not as a surface filter, as would be the case with using only a single particle size. In either case, a slurry of silicon carbide is prepared in distilled, autoclaved water after the resin has been washed with distilled, autoclaved water numerous times.

A silicon carbide slurry for packing in a column, in accordance with an embodiment of the invention can be prepared according to the following description. A 5% weight/volume (w/v) slurry of silicon carbide is prepared in distilled, autoclaved water. Initially, 5 g of raw resin is mixed with 25 mL of distilled, autoclaved water. The slurry is allowed to sit until the bulk phase settles out, and the supernatant is removed and discarded. This process is repeated four times, in order to clean the resin sufficiently. Finally, the 5 g of washed silicon carbide is resuspended in 10 mL of distilled, autoclaved water in order to create the slurry. Typically, the slurry was then packed into glass columns, using either glass wool or coffee filters as the resin support, since neither was shown to have any filtering effects on their own.

In another embodiment silicon carbide is packed onto a resin support, which was shown to have no filtration effects on its own. The support was packed into a glass column, which was subsequently packed with silicon carbide particles of a single grit size. Alternatively, the silicon carbide particles can be packed in layers, such that the bed is comprised of particles of decreasing size, The slurry could also be packed into various other forms or could be packed on top of other surface filters, such that it acts as a filter aid.

Once the silicon carbide particle bed has been packed, liquid containing contaminating substances can be passed through the filter bed by gravitational force or mechanical means. This could include vacuums, pressure or pumps, The flow rate of the liquid through the filter bed will be variable, and will depend on the dimensions of the filter bed and the method by which the liquid is being passed.

Filtration will proceed at a constant flow rate, until the pressure builds up and the filter begins to exhibit signs of becoming clogged. At this point, the filter can be regenerated through a combination of methods. This may include the passing of a wash solution (which may be the same composition as the filtrate, or a different composition) through the filter in the same direction as the filtrate has been passed, and/or in the opposite direction. An elution solution may also be passed through the bed in the same manner. These solutions can be passed at various flow rates, again dependent on the dimensions of the filter bed. This will allow for the cleaning and regenerating of the filter, by removing substances that have been mechanically removed by the filter, and substances that have been absorbed by the filter.

By these same methods, substances can also be removed and recovered from a liquid using silicon carbide. Filtration proceeds in the same manner as above, and again filtration is terminated prior to the clogging of the filter. A wash solution is first passed through the filter bed, followed by an elution solution. In this case, the elution fractions will be collected, in order to recover any valuable product or by-product that has been removed by the silicon carbide through adsorption. Once the elutions are complete, the filter will be fully regenerated by the previously mentioned methods.

It is imperative in both the removal of substances, and the removal and recovery of substances, that filtration be terminated prior to the complete clogging of the filter. This will allow for the washing solutions and the elution solutions to be passed through the filter while it is still permeable.

Once the filter has been regenerated, filtration can again proceed, The filter may be regenerated numerous times before any change in the filtration characteristics of the silicon carbide are detected.

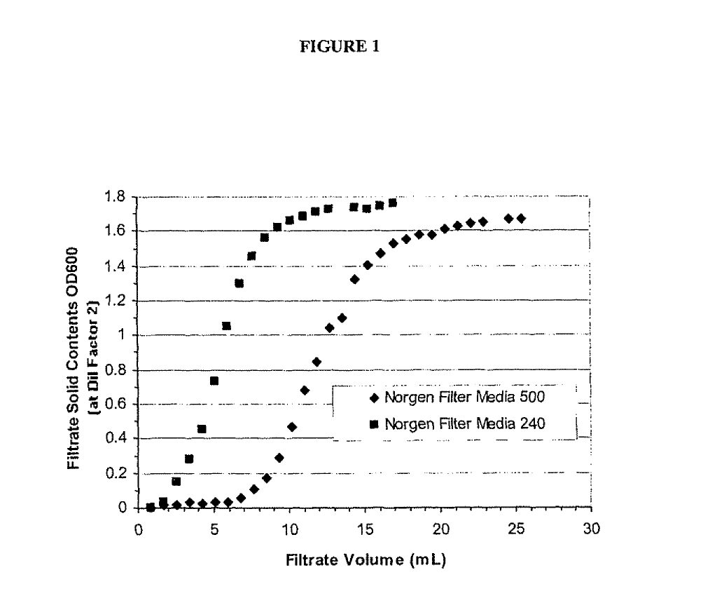

In an embodiment of the invention the effect of silicon carbide particle size was examined. Two columns were packed with silicon carbide particles that have average particle sizes of 57 microns and 27 microns. The resin was packed into glass columns using coffee filters as the resin support. The bed height of the columns was 1.5 cm, and the bed volumes were 2.6 mL. Once the columns were packed, a broth sample from a citric acid fermentation process was passed through the column at a flow rate of 2 mL/min using a peristaltic pump. One mL fractions were collected at the outlet of the columns, and were analyzed for solid content using absorbance readings at 600 nm. A filtration profile was generated for each column, by plotting the filtrate solid contents against the filtrate volume. The resulting filtration profile shown in FIG. 1 shows filtration of the substances present in the broth. This breakthrough curve is indicative of a combined process of adsorption and mechanical filtration. The smaller particle size column was found to display a higher filtration capacity.

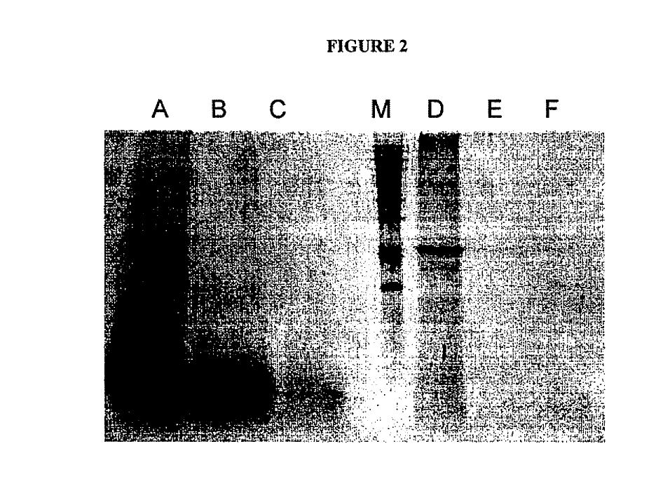

FIG. 2 shows an SDS-PAGE gel of citric acid fermentation broth prior to filtration, after filtration through a bed of silicon carbide particles, and after filtration with a commercially available method. Lanes A and D are the citric acid fermentation broth prior to filtration, Lanes B and E are citric acid fermentation filtrate after filtration using a commercially available method, and Lanes C and F are citric acid fermentation filtrate after filtration through a bed of silicon carbide particles. Lanes A-C are generated from a partially solubilized pellet of broth or filtrate, and Lanes D-F are generated from concentrated supernatant of broth or filtrate. Thus filtration through silicon carbide is as effective as commercially available filtration methods at removing proteins.

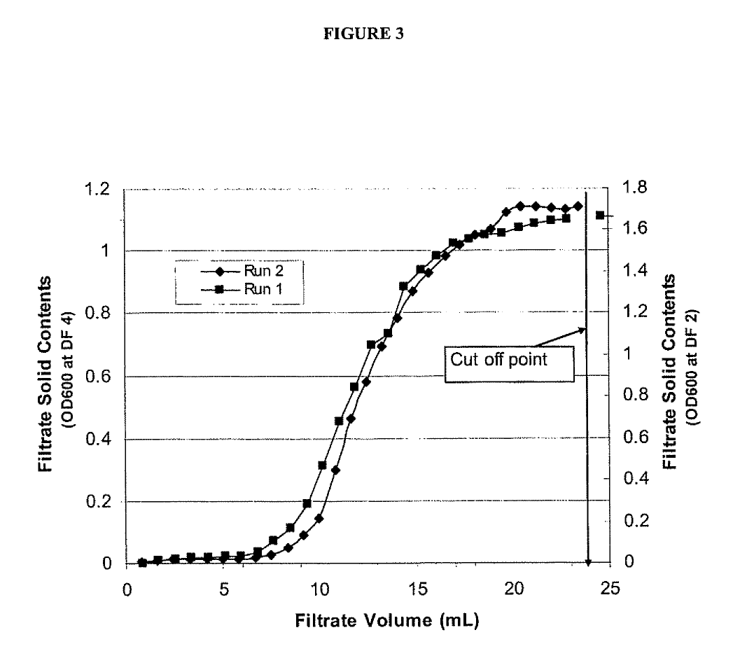

As shown in FIG. 3, filtration curves for the filtration of a citric acid fermentation broth indicating the cut-off point of filtration were created. In this embodiment of the invention, two columns were packed with silicon carbide particles that have an average particle size of 27 microns. The resin was packed into glass columns using coffee filters as the resin support. The bed height of the columns was 1.45 cm, and the bed volumes were 2.6 mL. Once the columns were packed, a broth sample from a citric acid fermentation process was passed through the columns at a flow rate of 2 mL/min using a peristaltic pump. Fractions were collected every 30 seconds, and the fractions were analyzed for solid content and volume. The cut-off point of filtration was determined from the volume collected in each fraction. As the filtration progressed, the pressure difference across the bed increased and the flow rate began to drop because the filter became clogged with solid particles. Thus the cut-off point was found to be 24 mL for these columns, and is the point where the flow rate and the fraction volumes first begin to drop.

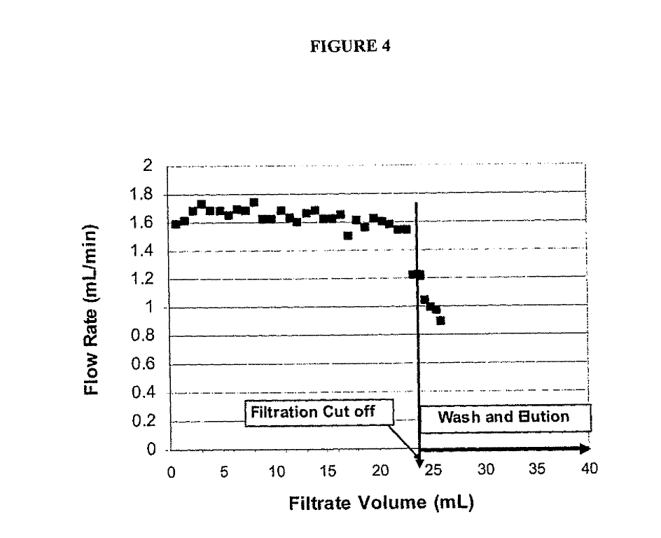

A flow rate profile was also established for the filtration of citric acid fermentation broth through a bed of silicon carbide particles. The flow rate profile is shown in FIG. 4. A bed of silicon carbide particles with an average particle size of 27 microns was packed, and citric acid fermentation broth was passed through the column at a flow rate of 2 mL/min using a peristaltic pump. The flow rate remains constant, until the filter begins to clog and the flow rate then drops as the pressure increases. It is at this point that filtration should be terminated, such that the wash and elution liquids can still be passed through the column while it is still permeable in order to either regenerate the column, or recover substances and regenerate the column. The figure indicates the filtration cut-off and wash and elution stages for this particular column.

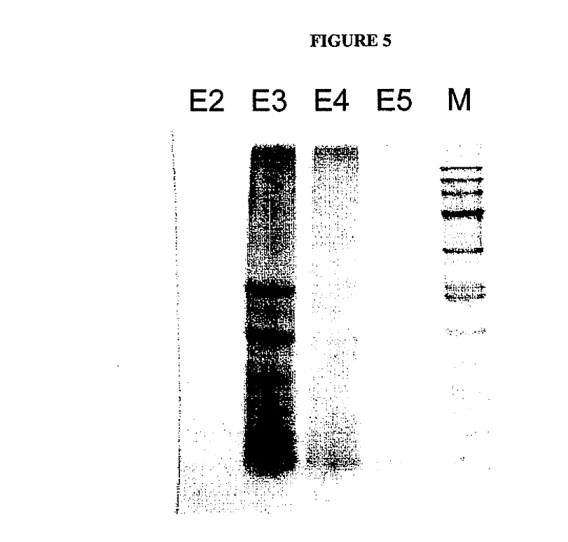

The filtration and recovery of a sample using an embodiment of the invention was measured. A column was packed with silicon carbide particles that have an average particle size of 27 microns. The resin was packed into glass columns using glass wool as the resin support. The bed height of the column was 1.5 cm, and the bed volume was 2.6 mL. Once the column was packed, a broth sample from a citric acid fermentation process was passed through the column at a flow rate of 2 mL/min using a peristaltic pump. Filtration was terminated prior to filtration cut-off, such that the column could be washed and eluted. The column was washed with 15 mL of wash solution (50 mM sodium acetate, pH 4.5) at a flow rate of 0.5 mL/min. Following washing, the column was eluted with elution buffer (50 mM phosphate buffer, pH 12) at a flow rate of 0.5 mL/min. The elution was collected in average fraction sizes of 0.85 mL. Fractions of each elution were run on an SDS-PAGE gel. Lanes E2-E5 of FIG. 5 represent elutions 2 through 5, while M is a molecular weight marker. Various bands of protein could be detected. Thus the filter bed was able to remove proteins, and the proteins could subsequently be recovered and removed from the silicon carbide.

While only specific embodiments of the invention have been described, it is apparent that variations can be made thereto. It is, therefore, the intention in the appended claims to cover all such variations as may fall within the true scope of the invention.

Various embodiments of the present invention having been thus described in detail by way of example, it will be apparent to those skilled in the art that variations and modifications may be made without departing from the invention. The invention includes all such variations and modifications as fall within the scope of the appended claims.

1. A method for use in industrial processes for removing substances from a liquid, comprising passing said liquid through a filter bed comprised of silicon carbide particles and collecting the liquid that passes through said filter bed for use in other applications.

2. The method of claim 1 wherein the silicon carbide particles are of a uniform particle size.

3. The method of claim 1 wherein the silicon carbide particles are of decreasing mean particle size as the liquid runs through the filter.

4. The method of claim 1 additionally comprising the step of washing and regenerating the filter bed using at least one regenerate liquid.

5. The method of claim 1 wherein said filter bed is used as a cake filter.

6. The method of claim 1 wherein said filter bed is used as a pressure filter.

7. The method of claim 1 wherein said filter bed is used as a vacuum filter.

8. The method of claim 1 wherein said filter bed is used as a deep bed filter.

9. The method of claim 1 wherein said filter bed is used as a surface filter.

10. The method of claim 1 wherein said silicon carbide is used as a filter aid in combination with other filters selected from membrane filters and surface filters.

11. A method for use in industrial processes for removing products and by-products present in a solution comprising passing said liquid through a filter bed comprised of silicon carbide particles and recovering said products and by-products from said filter bed.

12. The method of claim 11 wherein the products and by-products are recovered from the filter bed by elution.

13. The method of claim 11 wherein the silicon carbide particles are of a uniform particle size.

14. The method of claim 11 wherein the silicon carbide particles are of decreasing mean particle size as the liquid runs through the filter bed.

15. The method of claim 11 additionally comprising the step of washing and regenerating the filter bed using at least one regenerate liquid.

16. The method of claim 11 wherein at least one of the products and by-products are selected from nucleic acids, proteins, chemicals viruses, and bacteria.

17. The method of claim 11 wherein the liquid that passes through the column is collected for use in other applications.

18. The method of claim 11 wherein said filter bed is used as a cake filter.

19. The method of claim 11 wherein said filter bed is used as a pressure filter.

20. The method of claim 11 wherein said filter bed is used as a vacuum filter.

21. The method of claim 11 wherein said filter bed is used as a deep bed filter.

22. The method of claim 11 wherein said filter bed is used as a surface filter.

23. The method of claim 11 wherein said silicon carbide is used as a filter aid in combination with other filters selected from membrane filters and surface filters.
